(19) United States
(12) Patent Application Publication
(10) Pub. No.: US 2011/0095692 A1
(43) Pub. Date: Apr. 28, 2011

(54) CAMOUFLAGE PANEL

(75) Inventors: Leslie Charles Laycock, Essex (GB); Andrew Graham McCarthy, Essex (GB); John Martin Bagshaw, Essex (GB)

(73) Assignee: BAE SYSTEMS PLC, London (GB)

(21) Appl. No.: 12/993,053

(22) PCT Filed: May 13, 2009
(86) PCT No.: PCT/GB2009/050505

§ 371 Date: Nov. 16, 2010

(30) Foreign Application Priority Data
May 16, 2008 (GB) 0809129.0
Oct. 8, 2008 (EP) 08275062.1

(51) Int. Cl. H05B 37/02; H01J 1/62

(52) U.S. Cl. 315/158; 315/152; 313/498

(57) ABSTRACT

A camouflage panel arranged to be attachable to an outer area of a submarine is disclosed. The panel comprises a light emitter operable such that light is emitted from a surface of the panel. The intensity and colour of the emitted light being controllable in response to a control signal received from a sensor arranged to sense the intensity and colour of light in the region of the submarine. Apparatus comprising a number of such panels is also disclosed.

This invention relates to a camouflage panel. More particularly, the present invention relates to a camouflage panel that is arranged to be attachable to an outer area of a submarine and operable such that, when the submarine is submerged, it can be made less visible to surveillance aircraft.

It is often necessary or desirable for a submarine to operate near to the surface of the sea. In such circumstances, it is possible for the submarine to be spotted by aerial reconnaissance vehicles, whereas it would be preferable for the submarine to remain undetected. In deep areas, an observer will notice the submarine as a darker area than the surrounding sea-water, whilst in shallower coastal areas, the observer may be able to distinguish the submarine against the background of the sea bed. Previously, it has been known to paint submarines in shades of blue such that, when the submarine is near the surface of the sea, it is less visible to aerial surveillance aircraft. However, such camouflage has not been widely used, most probably because of problems associated with the gradual fading of the colour of the paint. It is an aim of the present invention to at least partially mitigate such problems. More particularly, it is an aim of the present invention to provide apparatus operable to camouflage a submarine at shallow depths.

In broad terms, the present invention resides in the concept of providing a submarine with active camouflage means, for example by providing an array of light-emitting panels to illuminate the sea around the submarine such that, form the air, the submarine is visibly more similar to the surrounding sea. It is recognised, in particular, that precise replication of the appearance of the sea-bed, or of the luminance of the surrounding sea water, is not necessary to achieve a significant and desirable camouflage effect to surveillance aircraft.

In accordance with a first aspect of the present invention, there is provided a camouflage panel arranged to be attachable to an outer area of a submarine, the panel comprising a light emitter operable such that light is emitted from a surface of the panel, the intensity and colour of said emitted light being controllable in response to a control signal received from a sensor arranged to sense the intensity and colour of light in the region of the submarine.

The light emitter may be operable such that a light of a substantially uniform intensity is emitted across at least a portion of the surface of the panel. It will be understood that by “substantially uniform”, it is meant that the intensity of the emitted light appears uniform to an aerial observer or aerial reconnaissance vehicle when the submarine is submerged at a depth of approximately 10 m to 30 m. The realisation that such a level of uniformity enables a submarine to be effectively camouflaged to aerial surveillance enables a variety of relatively inexpensive technologies to be used to provide light emission means for the panel.

For example, in one embodiment, the light emitter is operable to emit light into a light guide, which light guide comprises a light guiding medium bounded by a diffusing surface and a reflective surface, and an array of scatterers; the panel being arranged to be attachable to an outer area of a submarine such that the diffusive surface can diffuse light into water surrounding the submarine. Such panels can be fabricated from readily-available conventional components, and provide an adequately uniform light distribution at the surface of the panel.

The scatterers may be provided in the bulk of the guiding medium; or alternatively, the scatterers may be provided at the surface of the light guiding medium adjacent the reflective surface, for example as screen printed dots on the light guide. Light is emitted from the panel largely where the scatterers disrupt the guiding properties of the guiding medium, and so the arrangement of the scatterers can be used to determine the way in which light is emitted from the surface of the panel. Separating the scatters by a distance in the range 1 cm to 10 cm may lead to appropriately uniform light emission for panels in accordance with embodiments disclosed herein. The scatterers may be uniformly distributed, as may be appropriate for panels to be attached to flat areas of a submarine; or may be varied to account for curvature in the surface of the submarine. Alternatively, for large panels, the density of scatterers may increase radially outwards from the light emitter. Such variation can account, in part, for the reduction of light intensity at large distances from the light emitter.

The light emitter may be operable to emit a plurality of wavelengths of visible light. The colour of light emitted at the surface of the panel can then be controlled in response to the position of the submarine. For example, when the submarine is at shallow depth in deep water, the appropriate colour may be different to that required when the submarine is above a relatively shallow sea-bed—in coastal areas, for example. One way in which this can be achieved is to provide a light emitter comprising a tri-colour arrangement of light emitting diodes. In such arrangements, a uniform colour of light is achieved by ensuring that the separate diodes are spaced sufficiently closely together that the light emitted from the panel appears uniform to a relevant observer. The panel may comprise a plurality of light emitters. For large panels, the use of a plurality of light emitters, that are conveniently located around the edge of the panel, advantageously enables the intensity of light to be maintained across the surface of the panel. In one configuration described below, the panel is substantially rectangular, and a light emitter may be located at a corner of the panel. When a number of panels are combined, this results in there being one light emitter at each corner of each panel, with each light emitter emitting light into four separate panels.

In another embodiment disclosed herein, the light emitter comprises an electroluminescent material. Electroluminescent materials are commercially available in a number of forms, and emit light when subjected to an electric field. Since the material can be incorporated into the panel, there is no need for guiding media or scatterers; instead, the required degree of uniformity can be achieved by spacing the electroluminescent material across the panel. For example, the panel may be formed of a composite material having embedded therein a plurality of electroluminescent fibres. The panel may comprise three electroluminescent materials, each selected to emit a different colour of light to the others, the materials being arranged in proximity to one another such that the panel, to an observer, appears to emit a substantially uniformly coloured light. As above, it will be understood that by “substantially uniform”, is used herein to mean that the intensity of the emitted light appears uniform to an aerial observer or aerial reconnaissance vehicle when the submarine is submerged at a depth of approximately 10 m to 30 m.

According to a second aspect of the present invention, there is provided camouflage apparatus for a submarine, the apparatus comprising: a plurality of camouflage panels each attachable to an outer area of a submarine, each panel being operable to emit light from a surface of said each panel; and at least one sensor operable to sense the intensity and colour of light incident thereon and to transmit a signal encoding information relating to the intensity and colour of said light to said plurality of panels; the intensity and colour of the light emitted by said plurality of panels being determined in response to the signal received from the sensor. Such camouflage apparatus is able to adapt to the surroundings of the submarine, such that camouflage is obtained both when the submarine is in littoral areas, and when the submarine is submerged at low depths in deep waters. Furthermore, the use of a control signal, which may be produced in real time, enables the camouflage apparatus to replicate the shifting patterns of light resulting from motion at the surface of the sea.

The at least one sensor may be arranged to receive light from the region surrounding the submarine. In normal operating conditions, the sensor will be arranged to receive light from a region of the sea at approximately the same depth as the submarine. Alternatively, the sensor may be configured to receive light from a region of the sea at a slightly lower depth than the submarine, although not from a region in the shadow of the submarine.

The invention extends to a submarine comprising the panels or the apparatus defined above.

The invention may be performed in various ways, and embodiments thereof will now be described by way of example only, reference being made to the accompanying drawings, in which:

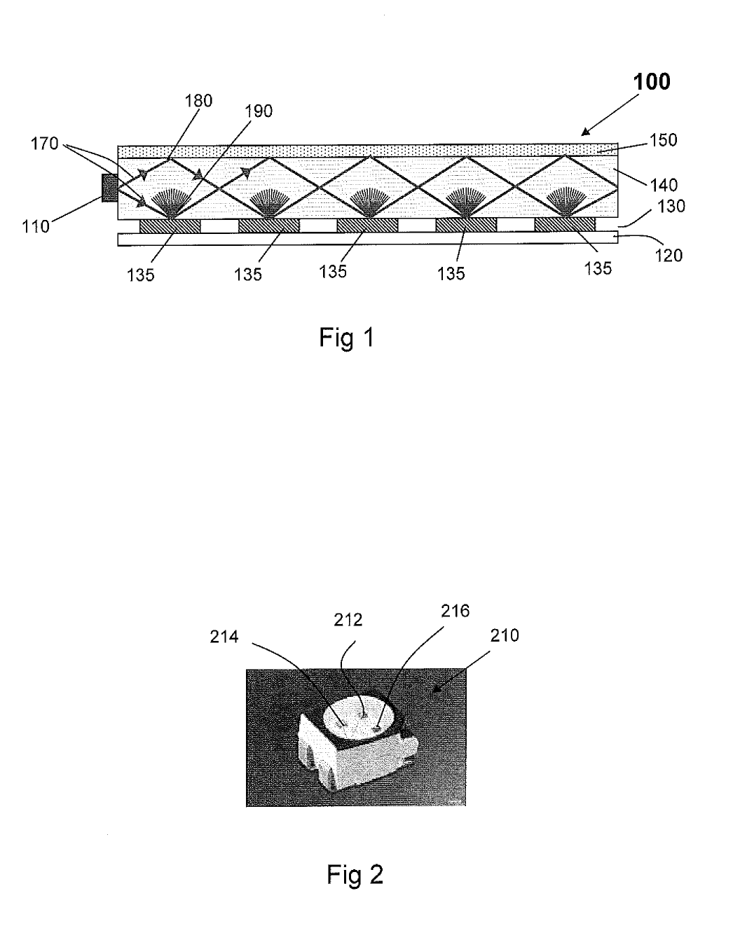

FIG. 1 is a schematic cross-sectional diagram of a panel in accordance with a first embodiment of the invention;

FIG. 2 is a photograph of a tri-colour light-emitting-diode package forming a part of the panel shown in FIG. 1;

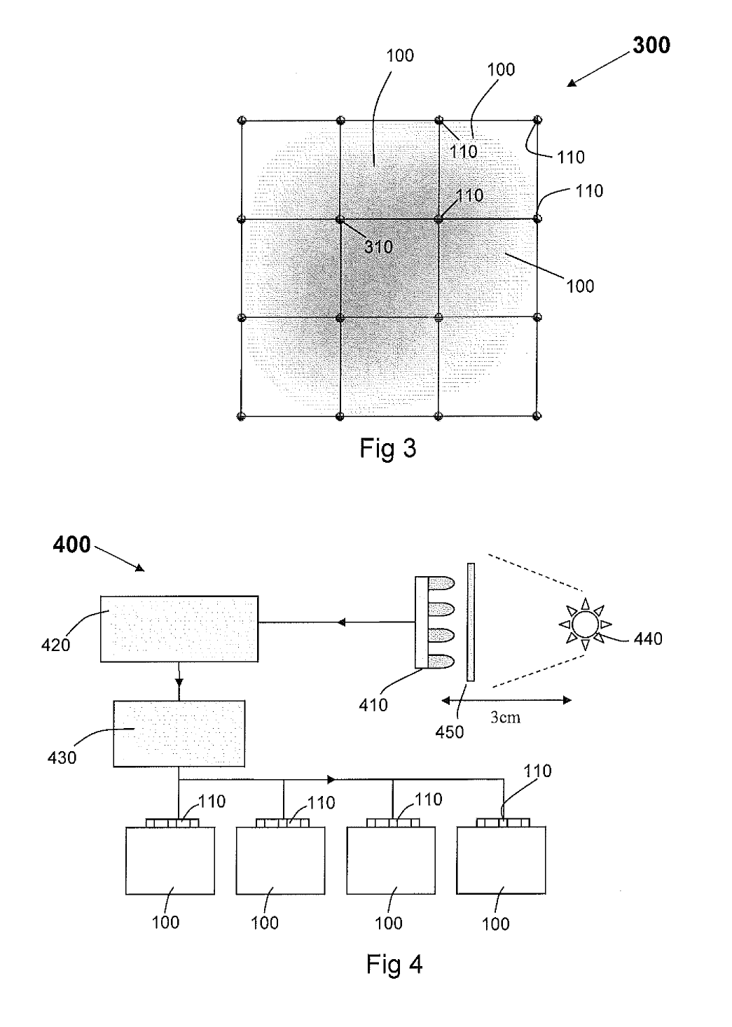

FIG. 3 is a schematic diagram of a number of the panels of FIG. 1 arranged in an array suitable for attachment to an exterior surface of a submarine;

FIG. 4 is a diagram of camouflage apparatus incorporating the panels of FIG. 1;

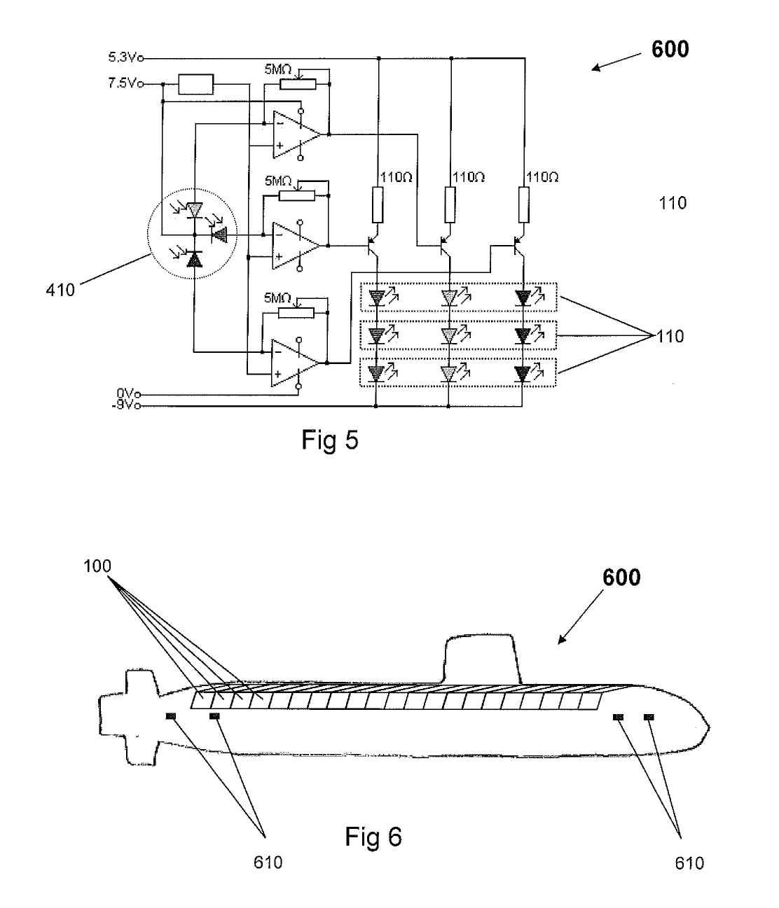

FIG. 5 is a schematic diagram illustrating the electronic circuit used for the apparatus illustrated in FIG. 4;

FIG. 6 is a diagram of a submarine using the panels of FIG. 1; and

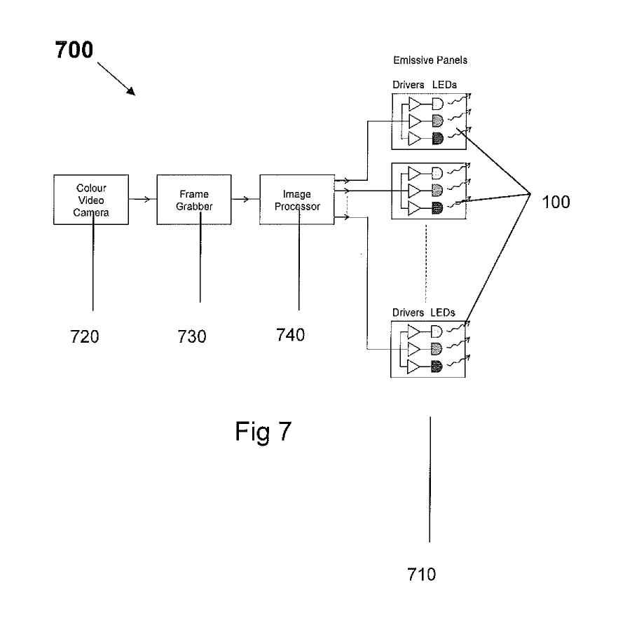

FIG. 7 is a schematic diagram of a further embodiment of the invention.

The present invention improves the stealth capability of a submarine by providing active camouflage operable when the submarine is operating at shallow depths. Frequently, the submarine is required to operate near the surface of the sea, at depths of approximately 10 m to 30 m, during the performance of sensitive aspects of a mission, when it is critical that the submarine is not observed by hostile forces. As disclosed herein, active camouflage can be achieved by attaching a number of panels to the surface of the submarine, each panel being configured to emit light of an intensity and colour at least approximately equal to that which would be observed from the sea or sea bed at the submarine's depth under similar ambient illumination conditions. To achieve the correct intensity and colour, a number of sensors configured to detect these ambient patterns of intensity and colour are provided, and used to determine the intensity and colour of light required. Thus the panels operate in conjunction with sensors so that the characteristics of the light emitted by the panels change in dependence on the ambient illumination conditions.

A panel 100 in accordance with a first embodiment of the invention is shown in FIG. 1. Panel 100 comprises a tri-colour light-emitting-diode (LED) package 110 attached to the side of a substantially planar layered partially-guiding structure. The partially guiding structure comprises a white reflective backing layer 120, a scattering layer 130 attached to the backing layer, a guiding layer 140, and a diffusive layer 150 attached to the surface of the guiding layer 140 opposing the scattering layer 130. Panel 100 is approximately 30 cm by 30 cm in size, and between 3 mm and 5 mm thick.

Tri-colour LED package 110 is shown in more detail in FIG. 2. The tri-colour LED package comprises three LED's 212, 214, 216 arranged in a package 220. The LED's are housed in a small recess in the package 220 such that the package can be surface-mounted to the edge of panel 100 (shown in FIG. 1). LED's 212, 214, 216 are, respectively, red, green, and blue LED's. The LED's are packaged closely together in housing 220 such that the combined effect of the LED's operating together, when viewed from a sufficient distance, is the emission of light of substantially uniform colour. Various colours of light can be achieved by varying the intensity of each of the individual LED's 212, 214, 216 relative to the other LED's. Thus, a blue light can be emitted from package 110 by providing power to only LED 216. The overall size of package 110 is approximately 3 mm by 3 mm by 3 mm.

Referring again to FIG. 1, it will be appreciated that there are several LED packages such as package 110 around the edge of the panel 100, but that only one such package is shown for clarity. The arrangement of packages is discussed in further detail below.

Reflective backing layer 120 is made from a white semi-glossy polymer sheet. The scattering layer 130 is formed by screen printing scattering centres 135 directly onto one surface of the guiding layer 140. The scattering centres are areas where the surface has been roughened in order to scatter incident light widely, such that light is emitted at least approximately uniformly across the surface of the diffuser 150. The scattering centres 135 are spaced from each other by approximately 1 cm on a regular array. By spacing the scattering centres regularly, it is expected that a uniform distribution of light across the diffuser 150 will be achieved. However, it is anticipated that in alternative embodiments, where larger panels are used in which the intensity of light may vary across the panel 100 with distance from the LED package 110, it may be preferable to apply a higher concentration of scattering centres further from the LED's, to compensate for the lower intensity of light further from the LED's. For example, it may be desirable to vary the density of scattering centres radially outwards from the light emitter. It may also be desirable to vary the concentration of scatterers form panel to panel. For example, at the periphery of the submarine (as viewed from above) it may be desirable to vary the concentration of scatterers from panel to panel in order to help break up the outline of the submarine as seen by an aerial observer; or it may be desired to vary the density of scatterers in areas of high curvature, where the guiding properties of layer 140 may be affected. Guiding layer 140 is formed from transparent acrylic sheet, and is the layer in which light from the LED's propagates. Layer 140 is 3 mm thick. Finally, diffuser 150 is provided such that the overall appearance of the illuminated panel is that of an approximately uniform glow, rather than there being a number of distinct visible scattering centres.

In operation of the panel 100, light is emitted from LED package 110 into the guiding layer 140. The intensity and colour of the light emitted by the LED package is controlled in response to light conditions in the region surrounding the submarine. The light conditions are detected by a sensor. The light emitted can be dynamically controlled in response to changes in the ambient light conditions. The sensor, its operation, and the necessary signal processing, is described in further detail below. Light emitted by the LED package 110 is illustrated schematically in FIG. 1 by rays 170. Rays 170 are guided within the guiding layer 140 by total internal reflection at points such as that labelled with reference numeral 180. Where rays 170 are incident on scattering centres, such as at the area labelled with reference numeral 190, light is scattered across a wide range of angles, resulting in some transmission through the diffusing layer 150. The combination of the guiding properties of layer 140 and scattering properties of layer 130 is arranged such that the diffusing layer is approximately uniformly illuminated.

FIG. 3 illustrates an arrangement 300 of panels 100 suitable for application to the exterior surface of a submarine. The arrangement 300 comprises nine panels 100, each of which is square in shape, and one LED package 110 at each vertex, emitting light towards the centres of the panels. Thus, as is shown in FIG. 3, each panel receives light from four LED packages. The area of each individual panel (30 cm by 30 cm) is selected to be small enough that the resolution of any aerial reconnaissance observation equipment would not be sufficient to resolve the presence of a number of separate panels, each potentially of a slightly different colour. The arrangement 300, in which the LED packages 110 are positioned at each vertex, is convenient in that it reduces the number of electrical connections to be made. Moreover, the arrangement is expected to reduce colour and luminance discontinuities at the edges of the panels 100. The arrangement 300 also provides a degree of redundancy should one of the LED packages fail for any reason, since there will be a degree of leakage of light between the different panels.

A small scale test apparatus 400, illustrated in FIG. 4, was constructed in order to demonstrate the panels 100. Apparatus 400 comprises four panels 100, each having three light emitters 110 positioned along an edge of the light guide. For the purposes of the test, an off-the-shelf light guide component is used in apparatus 400, with scattering centres separated by only 1 mm. The light emitters 110 for each panel receive a signal from an array of tricolour sensors 410, which signal has been processed via transimpedance amplifiers 420 and transistor buffers 430. The tricolour sensors used are conventional off-the-shelf components, available for example from MAZeT GmbH, and comprise a triad of red-, green-, and blue-sensitive photodetectors.

Transimpedance amplifiers 420 and transistor buffers 430 are arranged such that the intensity of light emitted from the panels 100 is equal to the intensity of light falling on the sensors 410. The transimpedance amplifiers 420 convert the signal from the sensors to a form suitable for driving the transistor buffers 430. The transistor buffers 430 allow the three LEDs of the same colour attached to each panel to be connected in series. This ensures that the same current flows through each LED and hence their light output will be closely matched. The arrangement of the circuit is shown in more detail in FIG. 5. Circuit 500 comprises array 410 of light detectors (indicated within the dashed circle) connected via transimpedance amplifiers and transistor buffers to light emitters 110. Each of the light emitters 110, which each comprise three differently coloured LED's, as indicated within the dashed boxes. Adjustment of the intensity of light emitted by each colour of LED is performed by adjusting the variable 5 MΩ feedback resistors that are connected across the amplifiers 420.

For the purposes of the test, an array 440 of white LED's operating at a current of 35 mA is used to provide the required light to stimulate the sensors, with a colour filter 450 being positioned between the LED's and the sensors in order to provide variation in the colour of light falling on the sensors 410. The test apparatus 400 resulted in bright, full colour luminance with good uniformity and efficiency. It is anticipated that, in submarine applications, lower luminance would be required, with larger panels. Such lower luminance could be achieved by more widely spacing the scattering centres, for example by between 1 cm and 10 cm, rather than 1 mm, thus spreading the light more thinly over a larger area.

FIG. 6 is a schematic illustration of a submarine 600 in accordance with another embodiment of the present invention. Submarine 600 incorporates an array of panels 100 arranged in the manner illustrated in FIG. 3, which array covers the upper surface of the submarine. In practice, it may be desirable for the panels to cover substantially the whole of the submarine, so as to mitigate the possibility of a dark outline being visible to aerial observers viewing the submarine at an angle. The panels 100 are shaped so as to conform to the part of the surface of the submarine to which they are attached, and are attached using a suitable adhesive. The process used for shaping of the panels will depend on the materials from which the panels are fabricated. In the case of polyethylene, the panels can be made to be sufficiently flexible that they can be shaped in situ. Panels made from less flexible materials, such as acrylic, may need to be heat-treated prior to application to the hull of the submarine.

Sensors 610 are arranged on the surface of the submarine to monitor the intensity and colour of light either at the level of the submarine, or below it, although not in its shadow. The sensors may therefore be positioned on the side of the submarine near its centreline, as shown in FIG. 6. Those skilled in the art will appreciate that any placement of sensors 610 appropriate to sense the ambient light conditions as described above will be suitable to enable the panels to emit a camouflaging intensity and colour of light. Each sensor comprises a triad of blue, green and red sensitive photo-detectors, as described above with reference to FIGS. 4 and 5. By providing an array of sensors, it is possible to allow the array of panels to emit light of dynamically varying intensity, thereby replicating variation in the intensity of light visible from any particular part of the sea to surveillance aircraft.

A panel according to a further embodiment of the invention uses an alternative means of light emission. Panels in accordance with this further embodiment of the invention are made from composite materials into which electroluminescent yarns have been incorporated. Electroluminescent yarns comprise an inner conductive core coated with an electroluminescent ink, a protective transparent layer surrounding the coated core, and a conductive yarn wrapped around the protected core. The electroluminescent ink generates light when a voltage is applied across it. Various colours can be generated by selection of the electroluminescent ink. By combining a number of yarns in one panel, each emitting a different colour of light, a wider range of colours can be achieved. Control of the light emission from the panels is achieved in the same way as described above with reference to the first embodiment of the invention. In a third embodiment of the invention, electroluminescent sheets are used to provide the light emission means. By using electroluminescent sheets of three different colours, a range of colours can be achieved for the emitted light. Small areas of red, green, and blue electroluminescent sheet are arranged in a triad pattern (similar to the arrangement of colour phosphors in a cathode-ray tube), with each triad being sufficiently small, and the individual elements of each triad being sufficiently close together, that only the combined effect of the three elements is resolvable to an aerial observer when the submarine is submerged. Electroluminescent sheets are commercially available in large sizes, flexible, and can be cut to size as required, and function using an ac driving voltage of 40 V or greater. Control of the intensity and colour of light emitted is achieved as described above, using similar light sensors and processing.

Camouflage apparatus 700 according to another embodiment of the invention is illustrated in FIG. 7. The apparatus 700 comprises a number of the panels 100 (illustrated in FIG. 1) arranged in an array 710. In the present embodiment, the input signals used to determine the intensity and colour of light emitted from the panels is provided by a colour video camera 720. The output of the camera 720 is received by a frame grabber 730 that derives a series of discrete frames from the camera output. The frames are processed by an image processor 740 that segments the captured image into a number of sub-images, there being one sub-image for each of the panels 100 in the array 710. The image processor 740 calculates an average colour for each of the sub-images from which the signals required to drive the red, green and blue LED's such that the light emitted by the panel mimics the average colour are calculated. In order to provide full coverage of panels across a submarine, it may of course be desirable to use a number of apparatuses 700, for example to cover both sides of the submarine.

It is to be noted that the above-described embodiments are in all respects exemplary. Variations and modifications to the above-described embodiments are possible without departing from the scope of the invention, which is defined in the accompanying claims. For example, the scattering layer 130, transparent guiding layer 140, and the diffusing layer 150, described in the above in relation to the first embodiment to be provided by separate layers, could be replaced by a single layer containing a large number of weakly scattering centres distributed within the layer. Such a layer could be realised, for example, from high optical quality polyethylene, which may contain crystalline structures on the scale of the wavelength of visible light. Scattering can occur from such structures, resulting in diffusion of light transmitted through the polyethylene. The degree of diffusion is dependent on the size and organisation of the structures.

Finally, it is also to be clearly understood that any feature described above in relation to any one embodiment may be used alone, or in combination with other features described, and may also be used in combination with one or more features of any other of the embodiments, or any combination of any other of the embodiments.

1. A camouflage panel arranged to be attachable to an outer area of a submarine, the panel comprising a light emitter operable such that light is emitted from a surface of the panel, the intensity and colour of said emitted light being controllable in response to a control signal received from a sensor arranged to sense the intensity and colour of light in the region of the submarine.

2. A panel as claimed in claim 1, wherein the light emitter is operable such that a light of a substantially uniform intensity is emitted across at least a portion of the surface of the panel.

3. A panel as claimed in claim 1, wherein the light emitter is operable to emit light into a light guide, which light guide comprises a light guiding medium bounded by a diffusing surface and a reflective surface, and an array of scatterers; the panel being arranged to be attachable to an outer area of a submarine such that the diffusive surface can diffuse light into water surrounding the submarine.

4. A panel as claimed in claim 3 wherein the scatterers are provided in the bulk of the guiding medium.

5. A panel as claimed in claim 3 wherein the scatterers are provided at the surface of the light guiding medium adjacent the reflective surface.

6. A panel as claimed in claim 5, wherein the scatterers comprise screen printed dots on the light guide.

7. A panel as claimed in claim 3, wherein the scatters are separated by a distance in the range 1 cm to 10 cm.

8. A panel as claimed in claim 3 wherein the scatterers are uniformly distributed.

9. A panel as claimed in claim 3 wherein the density of scatterers increases radially outwards from the light emitter.

10. A panel as claimed in claim 3, wherein the light emitter is operable to emit a plurality of wavelengths of visible light.

11. A panel as claimed in claim 3, wherein the light emitter comprises a tri-colour arrangement of light emitting diodes.

12. A panel as claimed in claim 3 comprising a plurality of light emitters.

13. A panel as claimed any claim 3, being substantially rectangular, and wherein a light emitter is located at a corner of the panel.

14. A camouflage panel arranged to be attachable to an outer area of a submarine, the panel comprising a light emitter operable such that light is emitted from a surface of the panel, the intensity and colour of said emitted light being controllable in response to a control signal received from a sensor arranged to sense the intensity and colour of light in the region of the submarine, wherein the light emitter comprises an electroluminescent material.

15. A panel as claimed in claim 14 wherein the panel is formed of a composite material having embedded therein a plurality of electroluminescent fibres.

16. A panel as claimed in claim 14 comprising three electroluminescent materials, each selected to emit a different colour of light to the others, the materials being arranged in proximity to one another such that the panel, to an observer, appears to emit a substantially uniformly coloured light.

17. (canceled)

18. (canceled)

19. Camouflage apparatus for a submarine, the apparatus comprising:
a plurality of camouflage panels each attachable to an outer area of a submarine, each panel being operable to emit light from a surface of said each panel;
and at least one sensor operable to sense the intensity and colour of light incident thereon and to transmit a signal encoding information relating to the intensity and colour of said light to said plurality of panels;
the intensity and colour of the light emitted by said plurality of panels being determined in response to the signal received from the sensor.

20. Apparatus as claimed in claim 19 wherein the at least one sensor is arranged to receive light from the region surrounding the submarine.

21. (canceled)

22. (canceled)

23. A panel as claimed in claim 1, wherein the light emitter is operable to emit a plurality of wavelengths of visible light.

24. A camouflage panel arranged to be attachable to an outer area of a submarine, the panel comprising a light emitter operable such that light is emitted from a surface of the panel, the intensity and colour of said emitted light being controllable in response to a control signal received from a sensor arranged to sense the intensity and colour of light in the region of the submarine,
wherein the light emitter is operable to emit light into a light guide, which light guide comprises a light guiding medium bounded by a diffusing surface and a reflective surface, and an array of scatterers; the panel being arranged to be attachable to an outer area of a submarine such that the diffusive surface can diffuse light into water surrounding the submarine.
